(19) United States
(12) Patent Application Publication
(10) Pub. No.: US 2010/0025392 A1
(43) Pub. Date: Feb. 4, 2010

(54) BAG FOR USE IN MICROWAVE OVEN AND HEAT/PRESSURE COOKING METHOD WITH THE BAG

(75) Inventors: Kohei Nishi, Tokyo (JP); Masatoshi Kamihara, Tokyo (JP); Masao Yasumatsu, Osaka (JP)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignees: NICHIWA ELECTRIC CORPORATION, Hyogo (JP); MEIWA PAX CO., LTD., Osaka (JP)

(21) Appl. No.: 11/910,919

(22) PCT Filed: Apr. 3, 2006
(86) PCT No.: PCT/JP2006/307071

§ 371 Date: Oct. 15, 2009

(30) Foreign Application Priority Data
Apr. 8, 2005 (JP) 2005-112915

(51) Int. Cl. H05B 6/80; B65D 33/01

(52) U.S. Cl. 219/725; 383/103

(57) ABSTRACT

There is provided a bag for use in a microwave oven enables heat/pressure cooking, and a heat/pressure cooking method using the bag.

The bag is formed by sealing a peripheral edge part of a pair of sheet members forming an upper surface and a lower surface, wherein the bag has a pressure releasing mechanism for making a part of the bag open to release pressure inside the bag to the outside so as to reduce the pressure when the pressure inside the bag rises and exceeds a predetermined value higher than atmospheric pressure, and the pressure releasing mechanism has a pressure keeping function for keeping the pressure inside the bag at least higher than atmospheric pressure even after the release of the pressure inside the bag.

### CROSS-REFERENCE TO RELATED APPLICATION

This is a national phase of International Patent Application No. PCT/JP2006/3071071, with an international filing date of Apr. 3^{rd}, 2006, which in turn claims priority from Japanese Patent Application No. (JP2005-112915) filed on Apr. 8^{th}, 2005, each incorporated by reference herein in its entirety.

### BACKGROUND OF THE INVENTION

1. Field of the Invention

The present invention relates to a bag for use in a microwave oven and a heat/pressure cooking method with the bag for use in a microwave oven. More specifically, the present invention relates to a bag for use in a microwave oven which safely and effectively discharges steam inside the bag in cooking using a microwave oven and keeps the pressure inside the bag higher than atmospheric pressure so as to enable heat/pressure cooking, and a heat/pressure cooking method with the bag for use in a microwave oven.

2. Description of the Background Art

There have hitherto been a large number of inventions with the aim of realizing heat cooking by heating a foodstuff in a microwave oven, using a bag for use in a microwave oven. As the invention with the aim of performing heat cooking as thus described, there is known an invention for preventing the inside of a bag for use in a microwave oven from being in an overpressurized state. According to such an invention, when the pressure inside the bag reaches a predetermined pressure value, the pressure load section, which is provided on the bag, opens so as to avoid being in the overpressurized state.

For example, in Patent Publication 1 (Tokukou hei-4-40005), an invention of a food container for use in a microwave oven which has a V-shaped pressure load section is disclosed. In the invention disclosed in Patent Publication 1, the V-shaped pressure load section opens when the pressure inside the bag reaches or exceeds a predetermined pressure. This invention is intended to prevent the bag from bursting in heat cooking.

Further, in Patent Publication 2 (Tokukai 2002-153217), a technique is disclosed which relates to a bag provided with a pressure load section and a small bag containing a liquid seasoning. In the invention disclosed in Patent Publication 2, the pressure load section opens when the pressure inside the bag reaches or exceeds a predetermined pressure, so as to prevent the bag from bursting. Meanwhile, the liquid seasoning inside the small bag is heated and evaporates, so that the small bag with the liquid seasoning sealed therein bursts. Consequently, the liquid seasoning and a foodstuff may be mixed and heat-cooked in the bag according to the invention of Patent Publication 2.

However, in the inventions disclosed in Patent Publications 1 and 2, since the pressure load section opens when the pressure inside the bag reaches or exceeds a predetermined value, the pressure inside the bag rapidly falls, and hence it has been impossible to perform pressure cooking with the bag for use in a microwave oven according to these inventions.

The present invention was made in view of such circumstances, and has an object to provide a bag for use in a microwave oven which enables pressure cooking. This bag is capable of releasing pressure by a pressure releasing mechanism when the pressure inside the bag reaches or exceeds a predetermined value, so as to prevent the bag from bursting. Meanwhile, the pressure-releasing mechanism is further provided with a pressure keeping function, so that the pressure inside the bag may be kept higher than atmospheric pressure.

The other object is to provide a heat/pressure cooking method with the bag for use in a microwave oven described above.

### SUMMARY OF INVENTION

An invention according to one embodiment provides a bag for use in a microwave oven formed by sealing peripheral edge parts of a pair of sheet members forming the upper and lower surfaces thereof, wherein the bag comprises a pressure releasing mechanism for making a part of the bag open to release pressure inside the bag to the outside so as to reduce the pressure when the pressure inside the bag rises and exceeds a predetermined value which is higher than atmospheric pressure, wherein the pressure releasing mechanism has a pressure keeping function of keeping the pressure inside the bag at least higher than atmospheric pressure even after the releasing the pressure inside the bag, wherein the pressure releasing mechanism includes a pressure load section formed inwardly from the peripheral edge part, wherein the pressure load section is formed by bonding the upper surface sheet and the lower surface sheet in a predetermined shape with a certain bonding strength, wherein the pressure load section is formed apart from the peripheral edge part, wherein the certain bonding strength is higher than tensile strength of the upper surface sheet and lower than the bonding strength of the peripheral edge part, and wherein, when the pressure inside the bag reaches a predetermined value, a sheet tearing occurs in the upper surface sheet in the periphery of the pressure load section to form an opening in substantially the same shape as the pressure load section.

An invention according to one embodiment provides the bag for use in a microwave oven according to claim 4, wherein the pressure load section has a circular or a substantially circular shape.

An invention according to the other embodiment provides A heat/pressure cooking method using the bag according to the bag of the present invention comprising steps of; putting a foodstuff container containing a prepared foodstuff into the bag;

sealing the bag; and heating the bag; wherein the pressure releasing mechanism makes a part of the bag open to release the pressure inside the bag for reducing the pressure inside the bag, wherein the pressure releasing mechanism comprises a pressure keeping function for keeping the pressure inside the bag at a constant value higher than atmospheric pressure, and wherein heating is further performed under the constant pressure higher than atmospheric pressure.

By provision of these inventions, it is possible to completely solve the above-mentioned problems.

According to one embodiment of the present, while the pressure releasing mechanism is provided which is capable of releasing the pressure inside the bag, this pressure releasing mechanism has a pressure keeping function. This pressure releasing mechanism prevents the bag from bursting, and may simultaneously keep the pressure inside the bag higher than atmospheric pressure. Therefore, heat/pressure cooking may be performed using this bag.

The pressure load section is formed apart from the peripheral edge part. Therefore, when the pressure inside the bag rises, the pressure inside the bag concentrates in the periphery of the pressure load section. Further, the bonding strength of the pressure load section of the bag is set higher than the tensile strength of the upper surface sheet and lower than the bonding strength of the peripheral edge part. Therefore, when the pressure inside the bag rises, a sheet tearing occurs in the upper surface sheet in the peripheral edge part of the pressure load section to form an opening in substantially the same shape as the pressure load section, so that the pressure inside the bag may be reduced.

The size of this opening depends upon the size of the pressure load section. Therefore, the pressure inside the bag may be adjusted by the size of the opening. Namely, the pressure inside the bag after the release of the pressure may be adjusted by adjustment of the size of the pressure load section, so that the pressure inside the bag may be kept higher than atmospheric pressure.

According to one embodiment of the present invention, uniform pressure may be applied on the pressure load section by forming the pressure load section in a circular or a substantially circular shape. This allows reliable adjustment of the size of the opening. Since the pressure inside the bag after the release of the pressure may be adjusted by adjustment of the size of the opening, the pressure inside the bag may be kept higher than atmospheric pressure.

According to the other embodiment of the present invention, the bag according to claim 4 or 5 is used in order to pressure-cook a foodstuff. Even after release of the pressure inside the bag by the pressure releasing mechanism, the pressure inside the bag is kept higher than atmospheric pressure, so that the foodstuff inside the bag may be pressure-cooked.

Further, the foodstuff container containing a prepared foodstuff is put into the bag, so that the foodstuff container may be taken out of the bag and the foodstuff may be neatly arranged on a serving dish. Further, the work of transferring the foodstuff from the foodstuff container to another dish may be omitted and a meal may be taken using the foodstuff container as it is.

### BRIEF DESCRIPTION OF THE DRAWINGS

The best mode for carrying out the present invention is described.

Embodiments of the present invention are described with reference to the drawings.

FIG. 1 is a plan view showing a first bag.

FIG. 2 is a cross-sectional view taken along a line A-A of FIG. 1.

FIG. 3 is a plan view of the first bag immediately after a pressure load section of the first bag operates to form an opening.

FIG. 4 is a cross-sectional view taken along a line A-A of FIG. 3.

FIG. 5 is a plan view showing a second bag.

FIG. 6 is a cross-sectional view taken along a line A-A of FIG. 5.

FIG. 7 is a plan view of the second bag immediately after a pressure load section of the second bag operates to form an opening.

FIG. 8 is a cross-sectional view taken along a line A-A of FIG. 7.

FIG. 9 is a plan view showing a third bag having a triangle pressure load section.

FIG. 10 is a cross-sectional view taken along a line A-A of FIG. 9.

FIG. 11 is a view immediately after a pressure load section of the third bag operates to form an opening.

FIG. 12 is a plan view showing a fourth bag having a cut.

FIG. 13 is a cross-sectional view taken along a line A-A of FIG. 12 having a cut not penetrating an upper surface sheet.

FIG. 14 is a cross-sectional view taken along the line A-A of FIG. 12 having a cut penetrating the upper surface sheet.

FIG. 15 is a cross-sectional view taken along the line A-A of FIG. 12 showing a condition where the cut not penetrating the upper surface sheet operates in the fourth bag.

FIG. 16 is a cross-sectional view taken along the line A-A of FIG. 12 showing a condition where the cut penetrating the upper surface sheet operates in the fourth bag.

FIG. 17 is a plan view showing a fifth bag.

FIG. 18 is a cross-sectional view taken along a line A-A of FIG. 17, having a cut not penetrating an upper surface sheet.

FIG. 19 is a cross-sectional view taken along the line A-A of FIG. 17, having a cut penetrating the upper surface sheet.

FIG. 20 is a cross-sectional view taken along the line A-A of FIG. 17 showing a condition where a film and the cut not penetrating the upper surface sheet operate in the fifth bag.

FIG. 21 is a cross-sectional view taken along the line A-A of FIG. 17 showing a condition where the film and the cut penetrating the upper surface sheet operate in the fifth bag.

FIG. 22 is a view of ingredients of “chicken and egg bowl (Japanese meal called ‘oyakodon’)” during heat/pressure cooking using the first bag according to the first embodiment.

FIG. 23 is a perspective view after cooking of “chicken and egg bowl” is completed.

### DETAILED DESCRIPTIONS

A bag for use in a microwave oven according to the present invention includes a pressure releasing mechanism having a pressure keeping function, and is formed by sealing a peripheral edge part of a pair of sheet members that forms an upper surface and a lower surface.

It should be noted that in the present specification, for the sake of convenience, an upper surface in an “upper surface sheet” merely refers to a top and a lower surface in a “lower surface sheet” merely refers to a back when the bag is placed, and the upper and lower surfaces are reversed by turning over the bag.

This bag is formed by sealing the peripheral edge part of a pair of sheet members. This peripheral edge part is formed at a predetermined ratio to the peripheral length of the bag. For example in a case of a bag having a square shape of 20 cm on each side in a plan view, its peripheral edge part is a portion not longer than 2 cm, preferably not longer than 1 cm, and inwardly from the rim sides of the sheet members. Further, the bonding strength of this sealed portion changes correlatively with the strength of the pressure load section described in later-described embodiments.

The shape and size of this bag are not particularly limited, but may be set appropriately to a shape and size desired by the user.

The pressure releasing mechanism functions to open a part of the bag to release pressure inside the bag to the outside so as to reduce the pressure when the pressure inside the bag reaches the predetermined pressure value.

Meanwhile, this pressure releasing mechanism has a pressure keeping function. Using this function, the pressure inside the bag may be kept higher than at least atmospheric pressure even after the part of the bag is opened.

The pressure at the time of making the part of the bag open is appropriately set in accordance with later-described methods for forming the pressure load section or a cut.

The pressure inside the bag kept after the opening is not particularly limited so long as it is higher than atmospheric pressure, but is preferably set to 1 to 1.5 atm, more preferably 1.2 to 1.3 atm.

It should be noted that this pressure is not higher than the predetermined pressure value at the time of opening the part of the bag.

The pressure keeping function is a function of keeping the pressure inside the bag higher than at least atmospheric pressure even after release of the pressure by the pressure releasing mechanism.

In the following, described are embodiments of this bag for use in a microwave oven, which includes the pressure releasing mechanism having the pressure keeping function.

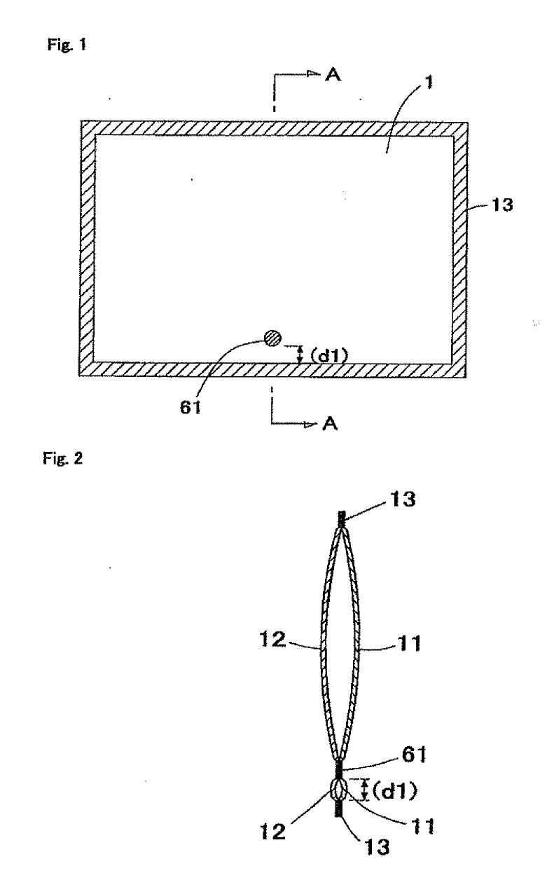

A first bag 1 according to a first embodiment of the bag is described. FIG. 1 is a plan view showing the first bag 1. FIG. 2 is a cross-sectional view taken along a line A-A of FIG. 1. This first bag 1 has a pair of an upper surface sheet 11 and a lower surface sheet 12, and each peripheral edge part 13 of the upper surface sheet 11 and the lower surface sheet 12 are sealed.

The shape of this pair of the sheets is not particularly limited, but is preferably formed in a quadrangular shape. This is because a quadrangle is considered to be the easiest shape to be formed and to be used by the user.

The first bag 1 has a pressure releasing mechanism made up of a pressure load section 61. Using this pressure releasing mechanism, the pressure inside the bag may be released. The pressure load section 61 has a predetermined shape, and is formed by bonding part of the upper surface sheet 11 and the lower surface sheet 12 (see FIG. 2)

It should be noted that in the present invention, the pressure load section is bonded by heat sealing, and formed by sealing in the same manner as the peripheral edge part 13.

Although the shape of the pressure load section 61 in a plan view is not particularly limited, but is preferably a substantially circular shape. This substantially circular pressure load section 61 is capable of making the pressure inside the first bag 1 uniform when the pressure inside the first bag 1 is applied to the pressure load section 61. Further, this substantially circular pressure load section 61 is capable of improving the strength of the pressure load section 61.

The size of the pressure load section 61 in a plan view is appropriately set in accordance with the size (shape) of the first bag 1 itself. For example, when the first bag 1 is formed in a rectangular shape of 25×16 cm in a plan view, the pressure load section 61 is formed as a circular one having a diameter of 5 mm, with distance of 8 mm from the substantial center of the longer side of the first bag 1.

This pressure load section 61 is arranged while having predetermined distance of d1 from the peripheral edge part 13. This predetermined distance of d1 is not particularly limited, but may be adjusted in accordance with the pressure applied inside the first bag 1.

For example, in a case where the shape of the first bag 1 in a plan view is a rectangle of 25×16 cm and pressure of 1 to 1.5 atm is released from the first bag 1, the pressure load section 61 is formed as a circular one having a diameter of 5 mm, with distance of 8 mum from the peripheral edge part 13.

The bonding strength of the upper surface sheet 11 and the lower surface sheet 12 that form the pressure load section 61 is set equal to the bonding strength of the upper surface sheet 11 and the lower surface sheet 12 that form the peripheral edge part 13.

It should be noted that the bonding strength of the peripheral edge part 13 is set to 10 to 60 N/15 mm, and the bonding strength of the pressure load section 61 is set to 10 to 60 N/15 mm, since it is the same as the bonding strength of the peripheral edge part 13.

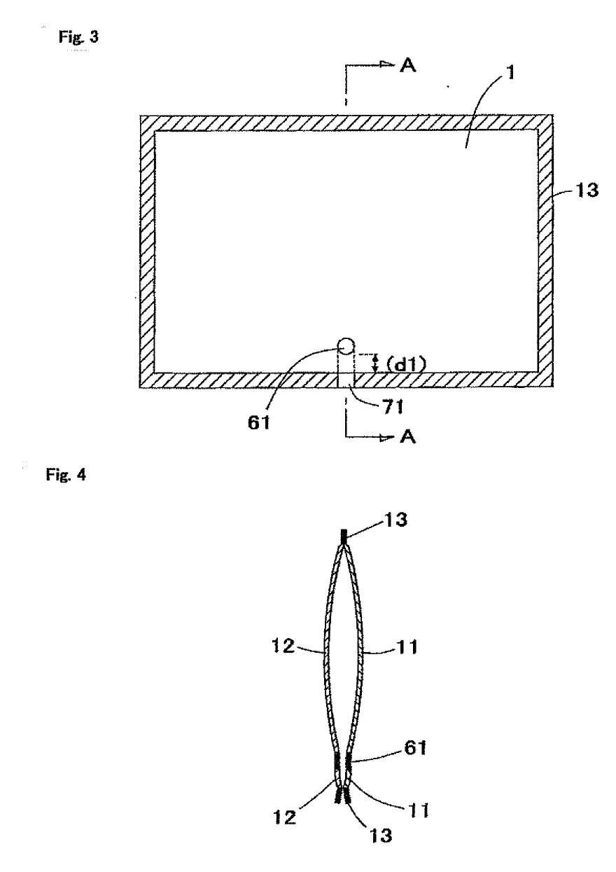

Next, the operation of the pressure load section 61 of the first bag 1 is described. FIG. 3 is a plan view of the first bag 1 immediately after the pressure load section 61 of the first bag 1 operates to form an opening 71. FIG. 4 is a cross-sectional view taken along a line A-A of FIG. 3.

When the first bag 1 is heated, water in a foodstuff and the like contained inside the first bag 1 is vaporized into steam. This steam expands the inside of the first bag 1.

The pressure is concentrated within the predetermined distance of d1 and the pressure in the vicinity of the predetermined distance of d1 thus rises. This is because the predetermined distance of d1 is the shortest distance between the pressure load section 61 and the peripheral edge part 13.

The strength of the pressure applied to the pressure load section 61 is the same as the one applied to the peripheral edge part 13 closest to the pressure load section 61. The bonding strength of the pressure load section 61 is set to be the same as the bonding strength of the peripheral edge part 13. Therefore, when the pressure inside the first bag 1 reaches a predetermined value, a sheet tearing occurs in the bonding section of the pressure load section 61, and a sheet tearing also occurs in the bonding section of the peripheral edge part 13 which is closest to the pressure load section 61. This results in formation of the opening 71 in the peripheral edge part 13.

The size of the opening 71 is set so as to make the pressure by the steam generated from the foodstuff inside the first bag 1 equal to the pressure released from the first bag 1.

The sizes of the pressure load section 61 and the opening 71 have a proportional relationship. When the size of the pressure load section 61 is increased, the size of the opening 71 to be formed also increases. This is because the width of the peripheral edge part 13 applied with the pressure increases with the increase in size of the pressure load section 61.

With the increase in predetermined distance of d1 between the pressure load section 61 and the peripheral edge part 13, the size of the opening 71 to be formed decreases. This is because, in a case where the predetermined distance of d1 is long, the pressure concentrated within the predetermined distance of d1 is small, so that the pressure to be applied on the peripheral edge part 13 may be made small.

The size of the opening 71 to be formed may be adjusted by adjustment of the size of the pressure load section 61 and the length of the predetermined distance of d1 between the pressure load section 61 and the peripheral edge part 13.

The pressure released from the first bag 1 depends upon the size of the opening 71. The pressure inside the first bag 1 may be kept at a constant value by making the pressure by the steam generated from the foodstuff inside the first bag 1 equal to the pressure released from the first bag 1. Namely, the pressure inside the first bag 1 may be kept at a constant value higher than atmospheric pressure by adjustment of the pressure released from the first bag 1. It should be noted that the pressure released from the first bag 1 may be adjusted by adjustment of the size of the opening.

As described above, the size of the opening 71 may be adjusted by adjustment of the size of the pressure load section 61 and the length of the predetermined distance of d1 between the pressure load section 61 and the peripheral edge part 13. It is therefore possible to keep the pressure inside the first bag 1 at a constant value higher than the atmospheric pressure.

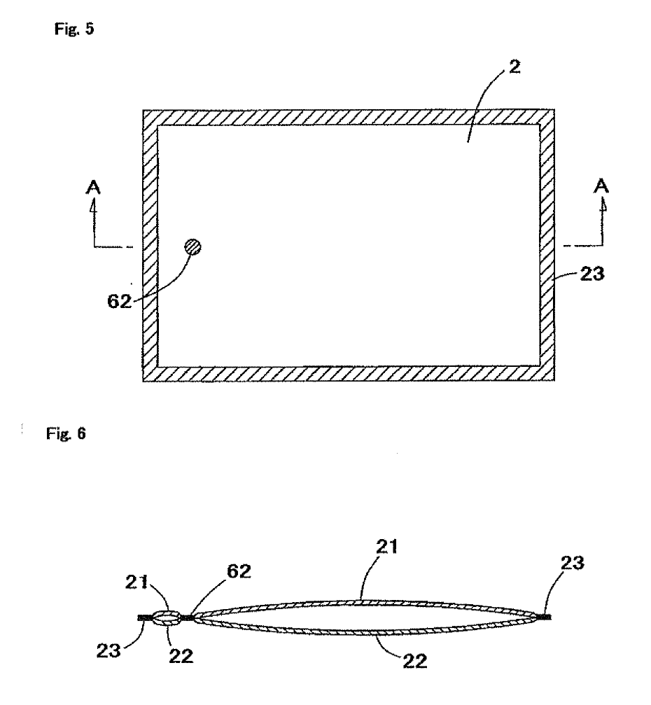

A second bag 2 as a second embodiment is described. FIG. 5 is a plan view showing the second bag 2. FIG. 6 is a cross-sectional view taken along a line A-A of FIG. 5. The second bag 2 is formed in the same manner as the first bag 1 in the first embodiment (see FIGS. 5 and 6).

Further, as in the first embodiment, the shape of this pair of sheets is not particularly limited, but is preferably formed in a quadrangular shape. This is because a quadrangle is considered to be the easiest shape to be formed and to be used by the user.

The second bag 2 has a pressure load section 62, as does the first bag 1 in the first embodiment. Namely, the pressure load section 62 has a predetermined shape, and is formed by bonding of part of the upper surface sheet 21 to the lower surface sheet 22.

Although the shape of the pressure load section 62 in a plan view is not particularly limited and may be appropriately set and formed by the user, it is preferably a substantially circular shape. Such a substantially circular pressure load section 62 is capable of making the pressure inside the second bag 2 uniform when the pressure inside the bag is applied to the pressure load section 62. Further, this substantially circular pressure load section 62 is capable of improving the strength of the pressure load section 62.

The size of the pressure load section 62 in a plan view is set in accordance with the size (shape) of the second bag 2 itself. For example, when the second bag 2 is a rectangular shape of 15×20 cm in a plan view, the pressure load section 62 is formed as a circular one having a diameter of 4 mm with distance of 2 mm from the substantial center of the shorter side of the rectangle.

The bonding strength of the upper surface sheet 21 and the lower surface sheet 22 that form the pressure load section 62 is set lower than the bonding strength of a peripheral edge part 23. Namely, a difference in bonding strength is made between the pressure load section 62 and the peripheral edge part 23.

This difference in strength is not particularly limited, but is formed so as to be not larger than 50 N/15 mm. This is because, with such a difference in strength made, an opening 72 may be effectively formed at the periphery of the pressure load section 62 as described later.

It should be noted that the bonding strength of the peripheral edge part 13 is set to 10 to 60 N/15 mm, and the bonding strength of the pressure load section 62 is set to 10 to 30N/15 mm.

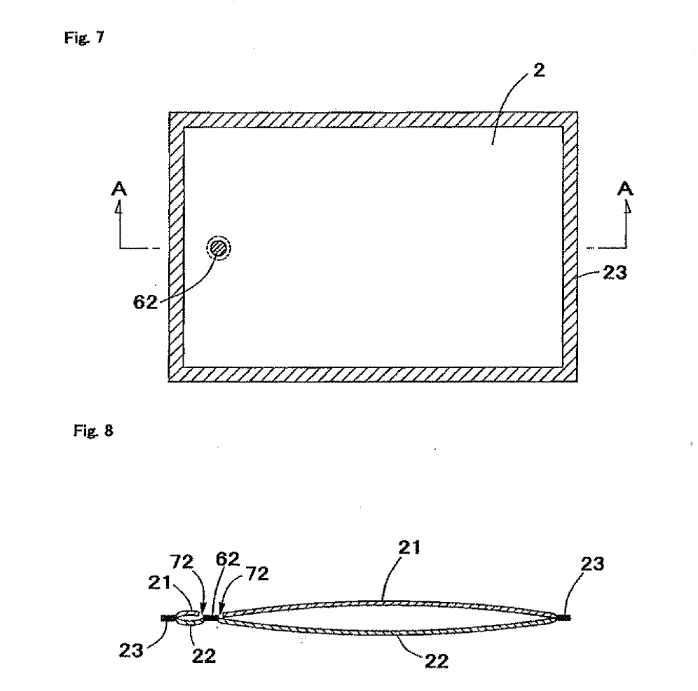

Next, the operation of the pressure load section 62 of the second bag 2 is described. FIG. 7 is a plan view of the second bag 2 immediately after the pressure load section 62 of the second bag 2 operates to form the opening 72. FIG. 8 is a cross-sectional view taken along a line A-A of FIG. 7.

When the second bag 2 is heated, water in a foodstuff and the like contained inside the second bag 2 is vaporized into steam. This steam expands the inside of the second bag 2.

At this time, the pressure is concentrated in the periphery of the pressure load section 62, and the pressure in the periphery of the pressure load section 62 thus rises. It should be noted that the bonding strength of the pressure load section 62 is set higher than the tensile strength of the upper surface sheet 21.

When the pressure inside the second bag 2 reaches a predetermined pressure value, the pressure higher than the tensile strength is applied on the upper surface sheet 21 in the periphery of the pressure load section 62. At this time, since there is a difference in bonding strength between the pressure load section 62 and the peripheral edge part 23, a sheet tearing occurs in the upper surface sheet 21 in the periphery of the pressure load section 62, and the opening 72 having substantially the same shape as the pressure load section 62 is formed in the upper surface sheet 21 (see FIGS. 7 and 8).

The opening 72 is formed to have such a size as to make the pressure by the steam generated from the foodstuff inside the second bag 2 equal to the pressure released from the second bag 2.

The sizes of the pressure load section 62 and the opening 72 have a proportional relationship. As the size of the pressure load section 62 increases, the size of the opening 72 to be formed also increases. This is because the opening 72 is formed around the pressure load section 62. The size of the opening 72 to be formed may be adjusted by adjustment of the size of the pressure load section 62.

The pressure inside the second bag 2 may be kept at a constant value higher than atmospheric pressure by making the pressure by the steam generated from the foodstuff inside the second bag 2 equal to the pressure released from the second bag 2. The pressure released from the second bag 2 depends upon the size of the opening 72. As in the first bag 1, the pressure inside the second bag 2 may be kept at a constant value higher than atmospheric pressure by adjustment of the pressure released from the second bag 2. It should be noted that the adjustment of the pressure released from the second bag 2 may be adjusted by adjustment of the size of the opening.

As described above, as in the first bag 1, the size of the opening 72 may be adjusted by adjustment of the size of the pressure load section 62, and it is thereby possible to keep the pressure inside the second bag 2 at a constant value higher than the atmospheric pressure.

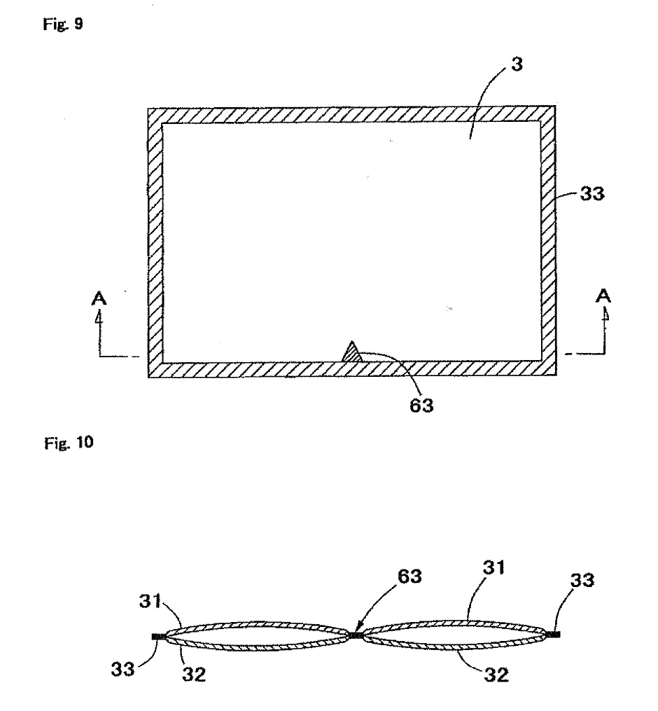

A third bag 3 as a third embodiment is described. FIG. 9 is a plan view showing the third bag 3 when a later-described pressure load section 63 is triangular. FIG. 10 is a cross-sectional view taken along a line A-A of FIG. 9. The third bag 3 is formed in the same manner as the second bag 2 in the second embodiment (see FIGS. 9 and 10).

Further, as in the second embodiment, the shape of this pair of sheets is not particularly limited, but is preferably formed in a quadrangular shape. This is because a quadrangle is considered to be the easiest shape to be formed and to be used by the user.

The third bag 3 has a pressure releasing mechanism made up of a pressure load section 63. The pressure inside the third bag 3 may be released by this pressure releasing mechanism. The pressure load section 63 is formed by bonding a part of the upper surface sheet 31 to the lower surface sheet 32 so as to form a predetermined shape (FIGS. 9 and 10).

The pressure load section 63 is formed in a polygonal shape in a plan view. With the pressure load section 63 formed in a polygonal shape, when the pressure inside the third bag 3 rises, the pressure to be applied on the pressure load section 63 is concentrated on each vertex. This pressure load section 63 is arranged such that one side of the pressure load section 63 is joined to one side of the bag.

The pressure load section 63 is preferably a triangle. This pressure load section 63 is arranged such that one side of the pressure load section 63 is joined to one side of the bag, and the pressure load section 63 is formed in a triangle shape (see FIGS. 9 and 10). In this case, when the pressure inside the third bag 3 rises, only one vertex may be defined as a pressure concentrated vertex. With only one vertex defined as the pressure concentrated vertex, only one portion at which a sheet tearing starts may also be set in the pressure load section. Consequently, the size of the opening may be reliably adjusted. The pressure inside the bag may be kept higher than atmospheric pressure by adjustment of the size of the opening.

It should be noted that, although the size of the polygon forming the pressure load section 63 is not particularly limited, it is preferably formed in a polygonal shape of about 5 to 20 mm on each side, more preferably about 5 to 10 mm.

Although the arrangement of the pressure load section 63 is not particularly limited, the pressure load section 63 is preferably arranged in a location apart from the corner by 10 to 50% of the side length of the bag. This location is where the pressure is the highest when the pressure inside the third bag 3 rises. The pressure inside the third bag 3 may be kept constant by releasing pressure from this position where the pressure is the highest.

For example, when the bag is a rectangle of 25×16 cm in a plan view, the pressure load section 63 in a regular triangle shape with one side of 0.5 cm is preferably set on the position apart from the corner by 12.5 cm in the longer side of the bag (see FIG. 9). In the case that it is placed on the shorter side, the pressure load section 63 is preferably set on the position apart from the corner by 8 cm.

A plurality of pressure load sections 63 may be provided on one side of the third bag 3. In this case, although the distance between the pressure load sections 63 is not particularly limited, at least it is a distance not smaller than 10 cm. This is because, with such arrangement, the entire pressure inside the third bag 3 may be kept uniform.

Further, the number of the pressure load sections 63 is not particularly limited, but is preferably made to have a proportional relationship with the total of lengths of the sides of the third bag 3. For example, when it is set that one pressure load section 63 is provided with respect to 20 cm as the total of lengths of the sides of the third bag 3, two pressure load sections 63 are set when the total of the lengths of the sides of the third bag 3 is 40 cm, three pressure load sections 63 when the total of the lengths of the sides of the third bag 3 is 60 cm, and four pressure load sections 63 when the total of the lengths of the sides of the third bag 3 is 80 cm.

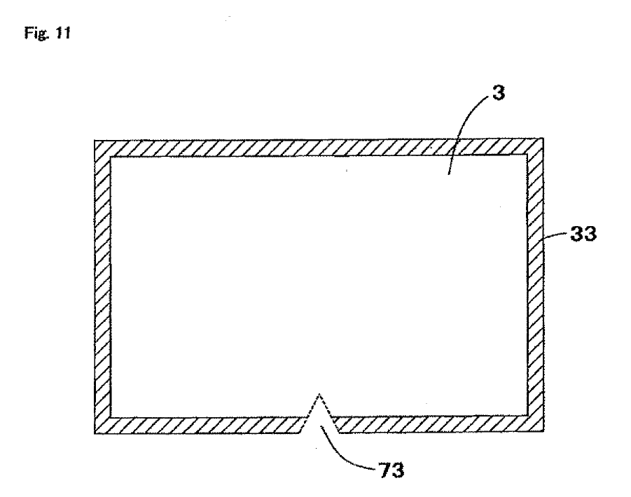

Next, the operation of the pressure load section 63 of the third bag 3 is described. FIG. 11 is a view immediately after the pressure load section 63 of the third bag 3 operates to form an opening 73.

When the third bag 3 is heated, water in a foodstuff and the like contained inside the third bag 3 is vaporized into steam. This steam expands the inside of the third bag 3.

The pressure is concentrated on the vertexes of the pressure load section 63, and the pressure of those portions thus rises. When the pressure inside the third bag 3 reaches a predetermined value, pressure stronger than the bonding strength of the pressure load section 63 is applied. At this time, a sheet tearing occurs in the bonding section of the pressure load section 63, and subsequently to this sheet tearing, a sheet tearing occurs also in the bonding section of a peripheral edge part 33 bonded with the pressure load section 63, so that the opening 73 is formed (see FIG. 11).

The opening 73 is formed to have such a size as to making the pressure by the steam generated from the foodstuff inside the third bag 3 equal to the pressure released from the third bag 3.

The sizes of the pressure load section 63 and the opening 73 have a proportional relationship. As shown in FIG. 11, when the size of the pressure load section increases, the size of the opening 73 also increases.

The size of the opening 73 may be adjusted by adjustment of the size of the pressure load section 63.

The pressure inside the third bag 3 may be kept at a constant value higher than atmospheric pressure by making the pressure by the steam generated from the foodstuff inside the third bag 3 equal to the pressure released from the third bag 3. The pressure released from the third bag 3 depends upon the size of the opening 73. The pressure inside the third bag 3 may be kept at a constant value higher than atmospheric pressure by adjustment of the pressure released from the third bag 3. It should be noted that the adjustment of the pressure released from the third bag 3 may be adjusted by adjustment of the size of the opening 73.

As described above, the size of the opening 73 may be adjusted by adjustment of the size of the pressure load section 63, and it is thereby possible to keep the pressure inside the third bag 3 at a constant value higher than atmospheric pressure.

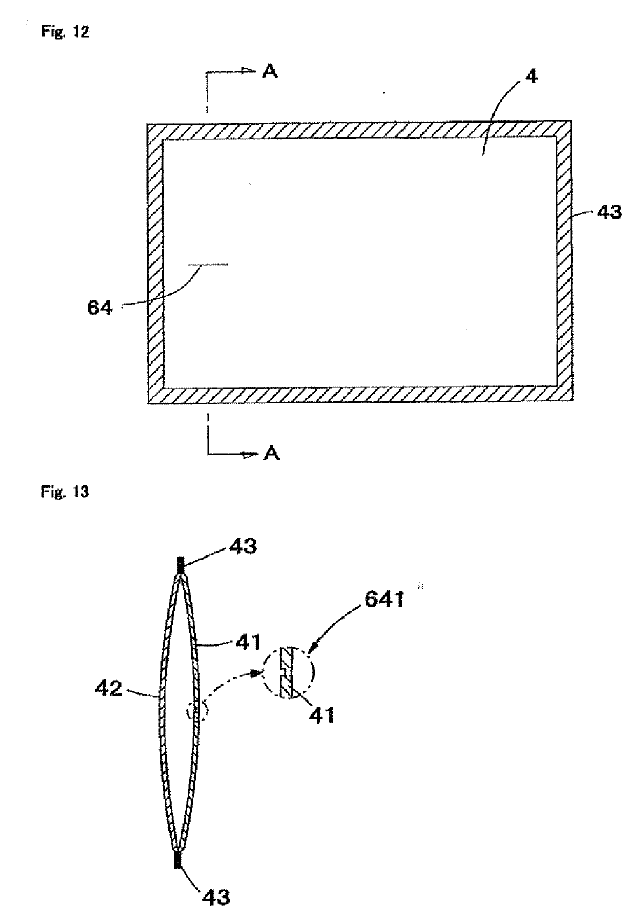

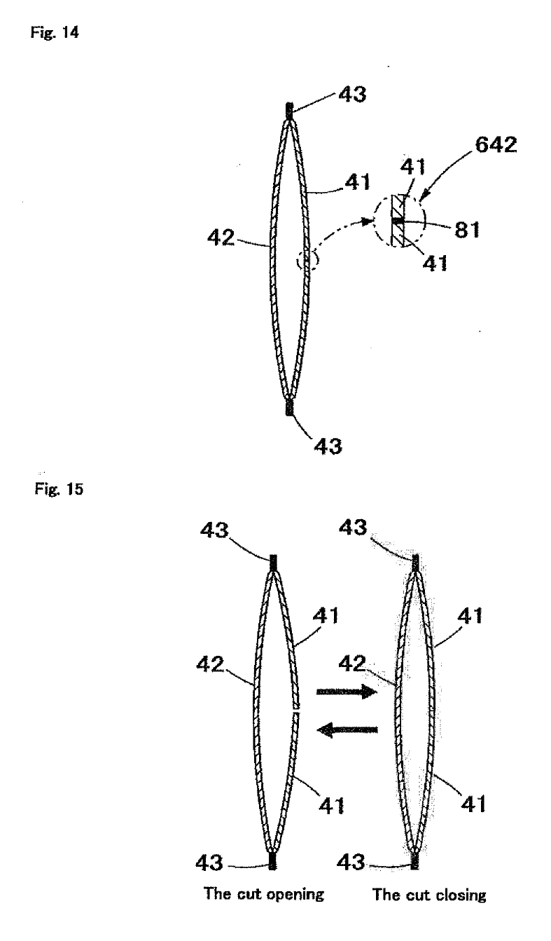

A fourth bag 4 as a fourth embodiment of the bag is described. FIG. 12 is a plan view showing the fourth bag 4 that has a cut 64. FIG. 13 is a cross-sectional view taken along a line A-A of FIG. 12, in which a cut 641 is of a type that does not penetrate an upper surface sheet 41 as described later. FIG. 14 is a cross-sectional view taken along the line A-A of FIG. 12, in which a cut 642 is of a type that penetrates the upper surface sheet 41 as described later. This fourth bag 4 is formed in the same manner as the third bag 3 in the third embodiment (see FIGS. 12, 13 and 14).

As in the third embodiment, the shape of this pair of sheets is not particularly limited, but is preferably formed in a quadrangular shape. This is because a quadrangle is considered to be the easiest shape to be formed and to be used by the user.

This fourth bag 4 has a pressure releasing mechanism made up of a cut 64. Pressure inside the fourth bag 4 is released by this pressure releasing mechanism. The cut 64 is provided in the upper surface sheet 41 (see FIGS. 13 and 14).

The shape of this cut 64 in a plan view is not particularly limited, but is preferably a straight line. The reason for this is that it is possible to make the cut 64 almost closed after it is opened when the pressure inside the fourth bag 4 falls to a predetermined value, so as to enhance the pressure keeping function of the cut. Another reason is that a production process for forming the cut 64 in a straight line shape is considered to be the easiest process. The straight line formed by this cut 64 is preferably set so as to have a length of about 1 to 30 mm, more preferably about 3 to 10 mm, and a width of about 0.01 to 1.0 mm, more preferably about 0.05 to 0.7 mm, when it is opened. This is for making the cut almost closed when the pressure inside the fourth bag 4 falls to or below a predetermined value.

There are two types of cuts 64. One is the cut 641 not penetrating the upper surface sheet 41 as shown in FIG. 13. The other is the cut 642 penetrating the upper surface sheet 41 as shown in FIG. 14.

The cut 641 not penetrating the upper surface sheet 41 is described. The depth of the cut 641 is not particularly limited, but is preferably set to 20 to 50% of the thickness of the upper surface sheet 41.

The cut 641 may be provided in either the outer surface or the inner surface of the upper surface sheet 41, but is preferably provided in the inner surface. This is because, with the cut 641 provided in the inner surface, the cut 641 opens as soon as the pressure inside the fourth bag 4 reaches a predetermined pressure value.

The cut 642 penetrating the upper surface sheet 41 is described. In normal times, the cut 642 is closed with an adhesive 81, and the fourth bag 4 is sealed (see FIG. 14).

The reason for this is that the adhesive 81 usually seals the fourth bag 4 in sufficiently except when heating it to open the cut 642 (when the pressure inside the fourth bag 4 rises to the predetermined value).

This adhesive 81 secures the sealing degree of the fourth bag 4 in normal times, and bonds the cut 642 to an extent that the cut 642 opens at the time of heating (when the pressure inside the fourth bag 4 rises to the predetermined value). Further, as a material for the adhesive 81, a material that does not affect a human body is preferably used. This is because, even if this adhesive 81 adheres to a foodstuff inside the fourth bag 4 during heat/pressure cooking, safety of the foodstuff may be secured.

The adhesive 81 applied on the cut 642 penetrating the upper surface sheet 41 may facilitate adjustment of the pressure inside the fourth bag 4 when the cut 642 first opens.

As for the cut 641 not penetrating the upper surface sheet 41, the operation of bonding the cut 642 with the adhesive 81 may be omitted in the production process.

The number of the cuts 64 is appropriately set in accordance with the size (shape) of the fourth bag 4 itself. At this time, the cuts 64 are arranged at a predetermined interval. This predetermined interval is not particularly limited, but is preferably set to 1 to 4 mm, more preferably 2 to 3 mm.

The material of the upper surface sheet 41 is not particularly limited, but is preferably a thermoplastic material. It is more preferably polypropylene. This is because polypropylene is capable of enhancing various strengths provided in the bag and also securing heat resistance.

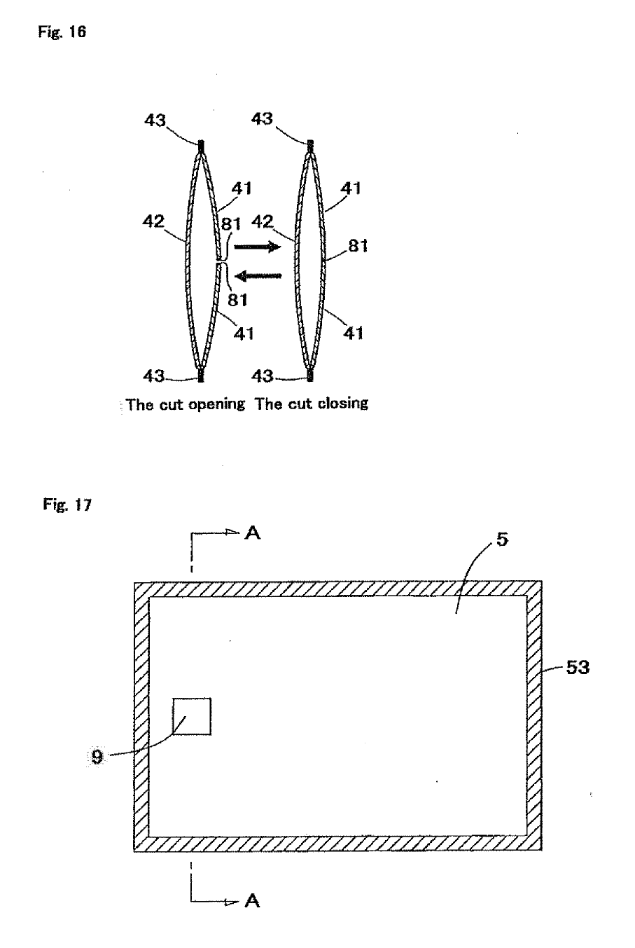

Next, the operation of the cut 64 of the fourth bag 4 is described. FIG. 15 is a cross-sectional view taken along the line A-A of FIG. 12 showing a condition where the cut 641 of the fourth bag 4 operates. FIG. 16 is a cross-sectional view taken along the line A-A of FIG. 12 showing a condition where the cut 642 of the fourth bag 4 operates.

The condition where the cut 641 of the fourth bag 4 operates is described.

When the fourth bag 4 is heated, water in the foodstuff and the like contained inside the fourth bag 4 is vaporized into steam. This steam expands the inside of the fourth bag 4.

At this time, when the pressure inside the fourth bag 4 reaches predetermined pressure value, the cut 641 opens to release the pressure inside the fourth bag 4 (see FIG. 15). The maximum width of the cut 641 at the time of opening is 0.05 to 0.7 mm as described above.

When the pressure inside the fourth bag 4 falls to a predetermined pressure value, this cut 641 almost closes to keep the pressure inside the bag at a predetermined value. By setting the length and width of the cut 641 to predetermined values as described above, it is possible to make the cut 641 almost closed (see FIG. 15).

Subsequently, when the pressure inside the fourth bag 4 rises again, the cut 641 opens. After releasing the pressure inside the fourth bag 4, the cut 641 almost closes again (see FIG. 15).

As described above, the cut 641 may repeatedly open and close in accordance with the changes in the pressure inside the fourth bag 4. Namely, since the cut 641 serves as a valve for keeping the pressure, it is capable of keeping the pressure inside the fourth bag 4 at a constant value higher than atmospheric pressure.

Next, the condition where the cut 642 of the fourth bag 4 operates is described.

When the fourth bag 4 is heated, water in the foodstuff and the like contained inside the fourth bag 4 is vaporized into steam. This steam expands the inside of the fourth bag 4.

At this time, when the pressure inside the fourth bag 4 reaches a predetermined value, the adhesive applied on the cut 642 peels off, and an opening is formed by the cut 642 penetrating the upper surface sheet. With this opening, the pressure inside the fourth bag 4 is released (see FIG. 16). The maximum width of the cut 642 at the time of opening is 0.05 to 0.7 mm as described above.

When the pressure inside the fourth bag 4 falls to a predetermined pressure value, this cut 642 almost closes to keep the pressure inside the bag at a predetermined value. By setting the length and width of the cut to predetermined values as described above, it was found that the cut 642 may be made almost closed (see FIG. 16). Further, since the adhesive is left in the cut 642, the cut 642 closes.

Subsequently, when the pressure inside the fourth bag 4 rises again, the cut 642 opens (see FIG. 16). After releasing the pressure inside the fourth bag 4, the cut 642 almost closes again.

As described above, the cut 64 may repeatedly open and close in accordance with the changes in pressure inside the fourth bag 4. Namely, since the cut 64 serves as a valve for keeping the pressure, it is capable of keeping the pressure inside the fourth bag 4 at a constant value higher than atmospheric pressure.

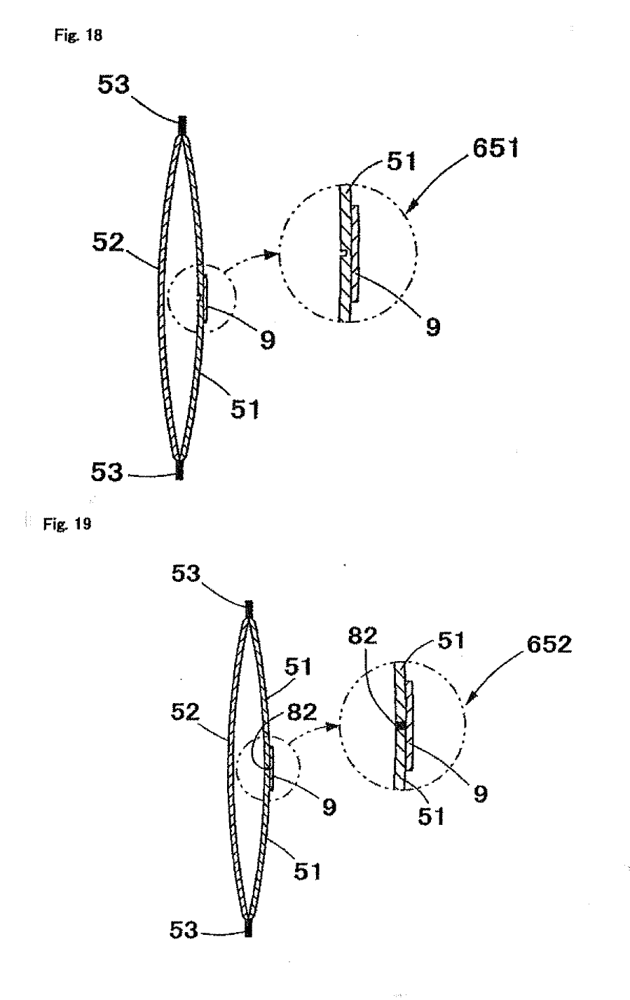

A fifth bag 5 as a fifth embodiment is described. FIG. 17 is a plan view showing the fifth bag 5. FIG. 18 is a cross-sectional view taken along a line A-A of FIG. 17, in which a cut 651 is of the above-mentioned type that does not penetrate an upper surface sheet 51. FIG. 19 is a cross-sectional view taken along the line A-A, in which a cut 652 is of the above-mentioned type that penetrates the upper surface sheet 51.

As in the fourth embodiment, the shape of this pair of sheets is also not particularly limited, but is preferably formed in a quadrangular shape. This is because a quadrangle is considered to be the easiest shape to be formed and to be used by the user.

This fifth bag 5 has a pressure releasing mechanism made up of a cut 65 as in the fourth embodiment. Pressure inside the fifth bag 5 is released by this pressure releasing mechanism. The cut 65 is provided in the upper surface sheet 51 (see FIGS. 18 and 19). Further, a film 9 is bonded so as to cover this cut 65.

The shape of this cut 65 in a plan view is not particularly limited, but is preferably a straight line as in the fourth embodiment. This is because a production process for forming a cut in a straight line shape is considered to be the easiest process.

Further, the straight line formed by this cut 65 is preferably set so as to have a length of about 1 to 30 mm, more preferably about 3 to 10 mm, and a width of about 0.01 to 1.0 mm, more preferably about 0.05 to 0.7 mm, at the time of opening. This is for making the cut 65 almost closed when the pressure in the fifth bag 5 falls to or below a predetermined value.

There are two types of cuts 65. As in the fourth embodiment, two types are considered. One is a cut 651 not penetrating the upper surface sheet 51 as shown in FIG. 18. The other is a cut 652 penetrating the upper surface sheet 51 as shown in FIG. 19.

The cut 651 not penetrating the upper surface sheet 51 is described. The depth of the cut 651 is not particularly limited, but is preferably set to 20 to 50% of the thickness of the upper surface sheet 51 (see FIG. 18).

This cut 651 may be provided in either the outer surface or the inner surface of the upper surface sheet 51, but is preferably provided in the inner surface. This is because, with the cut 651 provided in the inner surface, the cut 651 opens as soon as the pressure inside the fifth bag 5 reaches a predetermined pressure value.

The cut 652 penetrating the upper surface sheet 51 is described. In normal times, the cut 652 is closed with an adhesive 82 and the fifth bag 5 is sealed.

It is possible to make the cut 652 open at the time of heating (when the pressure inside the fifth bag 5 rises to the predetermined value). However, since the cut 652 is covered with the film, unlike the fourth embodiment, the sealing degree of the fifth bag 5 may be secured in normal times even when the bonding strength of the cut 652 is lower than the bonding strength of the cut 642 in the fourth embodiment.

As in the fourth embodiment, the adhesive 82 bonds the cut 652 to an extent that the cut 652 opens when the pressure inside the fifth bag 5 rises to the predetermined value. Further, it is preferable that a material of the adhesive 82 also does not affect a human body. This is because, even if this adhesive 82 adheres to the foodstuff inside the fifth bag 5 during heat/pressure cooking, safety of the foodstuff may be secured.

The number of the cuts is appropriately set in accordance with the size and shape of the fifth bag 5 itself. At this time, the cuts 65 are arranged at a predetermined interval. This predetermined interval is not particularly limited, but is preferably set to 1 to 4 mm, more preferably 2 to 3 mm.

Next, the film 9 is described.

The film 9 is a thin film, and although a material thereof is not particularly limited, a polypropylene or silicon resin is preferably used. The film 9 made of a polypropylene or silicon resin is capable of effectively forming a clearance between the film 9 and the cut 65 (described later).

The shape of the film 9 is not particularly limited, but is preferably formed so as to cover the entire face of the cut 65 and formed such that a clearance between the cut 65 and the film 9 (described later) may be formed (see FIGS. 18 and 19).

A specific size is that, when the length of the cut 65 is 10 mm, the film 9 is formed in a square shape of 20 mm on each side.

The film 9 is bonded to the sheet with the adhesive. The film 9 is bonded to an extent that, when the pressure inside the fifth bag 5 reaches a predetermined value, the film 9 slightly peels off the cut 65 to form a clearance (described later).

A material of the upper surface sheet 51 is not particularly limited, but is preferably a thermoplastic material. Polypropylene is more preferable. This is because polypropylene is capable of enhancing various strengths provided in the bag and also securing heat resistance, as the upper surface sheet of the fourth bag 4.

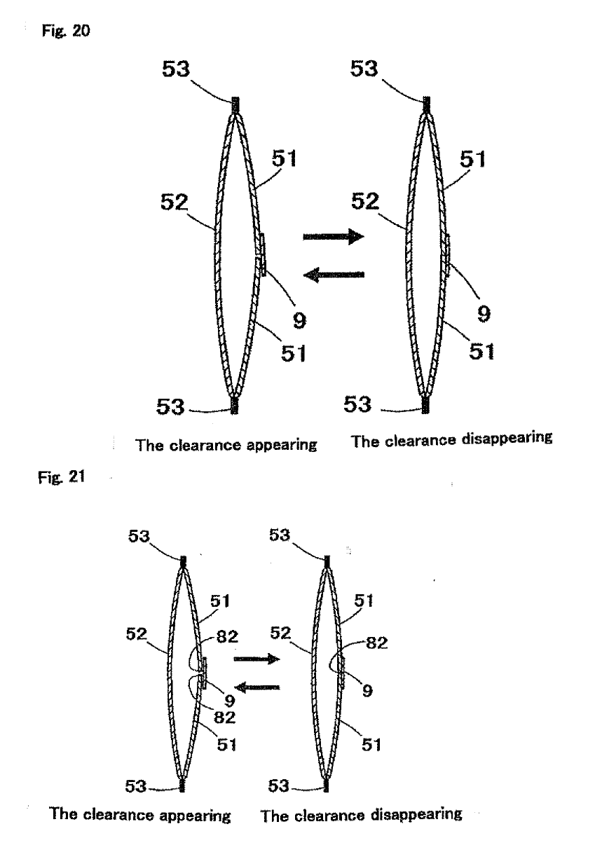

Next, the operation of the cut 65 of the fifth bag 5 is described. FIG. 20 is a cross-sectional view taken along the line A-A of FIG. 17 showing a condition where the cut 651 and the film 9 of the fifth bag 5 operate. FIG. 21 is a cross-sectional view taken along the line A-A of FIG. 17 showing a condition where the cut 652 and the film 9 of the fifth bag 5 operate.

The condition where the cut 651 and the film 9 of the fifth bag 5 operate is described.

When the fifth bag 5 is heated, water in a foodstuff and the like contained inside the fifth bag 5 is vaporized into steam. This steam expands the inside of the fifth bag 5.

When the pressure inside the fifth bag 5 reaches a predetermined value, the cut 651 opens to release the pressure inside the fifth bag 5 (see FIG. 20). The film 9 slightly peels off the cut 651 due to the pressure inside the fifth bag 5, and a clearance is formed between the film 9 and the cut 651, so that the pressure inside the fifth bag 5 is released from this clearance.

When the pressure inside the fifth bag 5 falls to a predetermined pressure value, the cut 651 almost closes and this clearance disappears (see FIG. 20). In this way, the pressure inside the bag is kept at a predetermined value.

When the pressure inside the fifth bag 5 rises again, the cut 651 opens and a clearance is again formed between the film 9 and the cut 651 (see FIG. 20). After the pressure inside the fifth bag 5 is released, the cut 651 closes again and the clearance disappears.

By opening/closing the cut 651 and by making the clearance formed/disappeared in accordance with the pressure inside the fifth bag 5, the cut 651 and the film 9 may serve as a valve for keeping the pressure. With this structure, the pressure inside the fifth bag 5 may be kept at a constant value higher than atmospheric pressure.

Next, the condition where the cut 652 and the film 9 of the fifth bag 5 operate is described.

When the fifth bag 5 is heated, water in the foodstuff and the like contained inside the fifth bag 5 is vaporized into steam. This steam expands the inside of the fifth bag 5.

At this time, when the pressure inside the fifth bag 5 reaches a predetermined value, the adhesive applied on the cut 652 peels off and the cut 652 opens to release the pressure inside the fifth bag 5 (see FIG. 21). The film 9 slightly peels off the cut 652 due to the steam inside the fifth bag 5, and a clearance is formed between the film 9 and the cut 652, so that the pressure inside the fifth bag 5 is released from this clearance.

When falling to a predetermined pressure value, the pressure inside the fifth bag 5 falls. At this time, the cut 652 almost closes with the adhesive that is left in the cut 652 (see FIG. 21). Simultaneously, the clearance disappears when the pressure inside the fifth bag 5 falls. Since the cut 652 has almost closed and the clearance has disappeared, the pressure inside the fifth bag 5 is kept at a predetermined value.

When the pressure inside the fifth bag 5 rises again, the cut 652 opens, a clearance between the film 9 and the cut 652 is formed again (see FIG. 21). After the pressure inside the fifth bag 5 is released, the cut 652 closes again and the clearance disappears.

By opening/closing the cut 651 and by making the clearance formed/disappeared in accordance with the pressure inside the fifth bag 5, the cut 652 and the film 9 may serve as a valve for keeping the pressure. With this structure, the pressure inside the fifth bag 5 may be kept at a constant value higher than atmospheric pressure.

A sixth bag as a sixth embodiment of the bag is described (not shown). This sixth bag is formed by combination of the characteristics of the fourth bag 4 and the fifth bag 5.

An opening is formed in the upper surface sheet of this sixth bag. As in the fifth bag 5, a film is bonded so as to cover the opening. The shape and size of this opening is not particularly limited.

The film is provided with a cut having a pressure keeping function as in the fourth bag 4. When the pressure inside the sixth bag rises, the cut in the film of the sixth bag shows the same operation as that of the cut 64 in the fourth bag 4, and thereby, the pressure inside the sixth bag may be kept at a constant value higher than atmospheric pressure.

Next, a heat/pressure cooking method using the bags according to the first to sixth embodiments is described.

This heat/pressure cooking method is intended to perform, by the use of the bags according to any of the first to sixth embodiments, pressure cooking on a foodstuff inside the bags using a microwave oven. The method is particularly characterized in that a foodstuff container is accommodated in the bags according to any of the first to sixth embodiments.

The foodstuff container is accommodated inside the bag according to any of the first to sixth embodiments. This foodstuff container is for holding a foodstuff, e.g. a dish, a cup, a rice bowl, a bowl, ovenware, a heat resistant dish and heat resistant glass, and is not particularly limited unless it is a metal foodstuff container which is not usable in a microwave oven.

A prepared foodstuff is held in the foodstuff container. The prepared foodstuff refers to what has already been seasoned and will be eatable state after heat/pressure cooking. For example, foodstuffs having been prepared in the case of cooking ingredients of “chicken and egg bowl” refers to chicken cut into bite-size pieces, onion cut into desired-size pieces, beaten egg, a source for simmering, and water. Note that seasoning is also included in the foodstuff.

The bag according to any of the first to sixth embodiments needs to be sealed after the foodstuff container is put thereinto. This is because the pressure cooking cannot be performed unless the bag is sealed. The method for sealing is not particularly limited, but heat sealing is preferably applied as in the peripheral edge part of the bag.

When the pressure inside the bags according to the first to sixth embodiments reaches a predetermined value, the pressure inside the bags according to the first to sixth embodiments is released by the pressure releasing mechanisms. Meanwhile, since the pressure releasing mechanism includes the pressure keeping function, the pressure inside the bags according to the first to sixth embodiments may be kept higher than atmospheric pressure. By keeping the pressure inside the bags according to the first to sixth embodiments higher than atmospheric pressure, foodstuffs inside the bags may be pressure-cooked.

By keeping the pressure inside the bags according to any of the first to sixth embodiments higher than atmospheric pressure, the foodstuffs inside the bag may be subjected to pressure cooking in addition to heat cooking. It is thereby possible to reduce the cooking time by using the bag according to any of the first to sixth embodiments, as compared with the bag only for heat cooking.

By keeping the pressure inside the bag higher than atmospheric pressure, a steam temperature inside the bag may rise to 100° C. or higher As described above, the pressure inside the bags according to any of the first to fifth embodiments may be kept at 1.2 to 1.3 atm. In response to this pressure, the steam temperature inside the bag according to any of the first to fifth embodiments may rise to 110 to 120° C.

Since the steam temperature inside the bags according to the first to fifth embodiments rises to 100° C. or higher, it is possible to kill bacteria that may not be killed in the condition where the steam temperature is 100° C. or less.

The heat/pressure cooking method according to the present invention is described with reference to an embodiment.

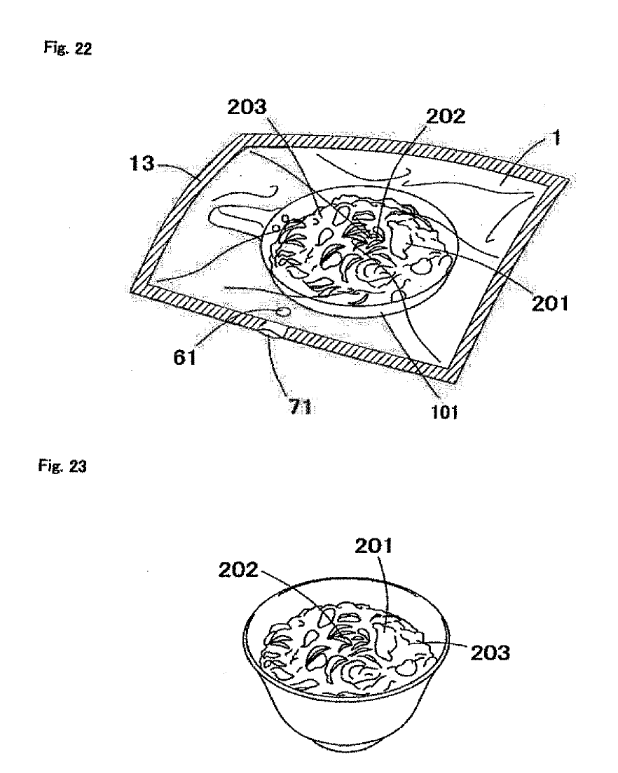

As the embodiment, a method for cooking ingredients of “chicken and egg bowl” is described. FIG. 22 is a view of ingredients of “chicken and egg bowl” in the process of heat cooking with the first bag 1 according to the first embodiment.

A flat-bottomed pan 101 is used as the foodstuff container. Chicken 201 cut into bite-size pieces, onion 202 cut into bite-size pieces, and beaten egg 203 added with a source for simmering and water, which are the prepared foodstuffs, are held respectively in appropriate amounts into the pan 101. This pan 101 is accommodated into the first bag 1, which is then sealed and heated in a microwave oven.

As the heating proceeds, the water in the foodstuffs is vaporized into steam. This steam expands the inside of the first bag 1.

When the pressure inside the first bag 1 rises, the opening 71 is formed by the pressure load section 61, and thereby, the steam in the first bag 1 is released from the opening 71. Meanwhile, the pressure inside the first bag 1 may be kept higher than atmospheric pressure due to the pressure keeping function provided to the pressure load section 61. Since the prepared foodstuffs inside the first bag 1 may be pressure-cooked by keeping the pressure inside the first bag 1 higher than atmospheric pressure, the ingredients of “chicken and egg bowl” may be cooked in shorter cooking time than the bag which is just for heat cooking.

Further, since the steam temperature inside the first bag 1 rises to 100° C. or higher by keeping the pressure inside the first bag 1 higher than atmospheric pressure, it is possible to sterilize the ingredients of “chicken and egg bowl”.

After the heat/pressure cooking, the flat-bottomed pan 101 containing the completed “chicken and egg bowl” ingredients is taken out of the first bag 1. It is possible to slide the ingredients of “chicken and egg bowl” from the pan 101 onto boiled rice put in a bowl to be neatly arranged.

1.-16. (canceled)

17. A bag for use in a microwave oven formed by sealing peripheral edge parts of a pair of sheet members forming the upper and lower surfaces thereof,
wherein the bag comprises a pressure releasing mechanism for making a part of the bag open to release pressure inside the bag to the outside so as to reduce the pressure when the pressure inside the bag rises and exceeds a predetermined value which is higher than atmospheric pressure,
wherein the pressure releasing mechanism has a pressure keeping function of keeping the pressure inside the bag at least higher than atmospheric pressure even after the releasing the pressure inside the bag,
wherein the pressure releasing mechanism includes a pressure load section formed inwardly from the peripheral edge part,
wherein the pressure load section is formed by bonding the upper surface sheet and the lower surface sheet in a predetermined shape with a certain bonding strength,
wherein the pressure load section is formed apart from the peripheral edge part,
wherein the certain bonding strength is higher than tensile strength of the upper surface sheet and lower than the bonding strength of the peripheral edge part, and
wherein, when the pressure inside the bag reaches a predetermined value, a sheet tearing occurs in the upper surface sheet in the periphery of the pressure load section to form an opening in substantially the same shape as the pressure load section.

18. The bag for use in a microwave oven according to claim 17,
wherein the pressure load section has a circular or a substantially circular shape.

19. A heat/pressure cooking method using the bag according to claim 17, comprising steps of:
putting a foodstuff container containing a prepared foodstuff into the bag;
sealing the bag; and
heating the bag;
wherein the pressure releasing mechanism makes a part of the bag open to release the pressure inside the bag for reducing the pressure inside the bag,
wherein the pressure releasing mechanism comprises a pressure keeping mechanism for keeping the pressure inside the bag at a constant value higher than atmospheric pressure, and
wherein heating is further performed under the constant pressure higher than atmospheric pressure.

20. A heat/pressure cooking method using the bag according to claim 18, comprising steps of:
putting a foodstuff container containing a prepared foodstuff into the bag;
sealing the bag; and
heating the bag;
wherein the pressure releasing mechanism makes a part of the bag open to release the pressure inside the bag for reducing the pressure inside the bag,
wherein the pressure releasing mechanism comprises a pressure keeping mechanism for keeping the pressure inside the bag at a constant value higher than atmospheric pressure, and
wherein heating is further performed under the constant pressure higher than atmospheric pressure.
